(19) United States
(12) Patent Application Publication
(10) Pub. No.: US 2005/0015500 A1
(43) Pub. Date: Jan. 20, 2005

(54) Method and system for response buffering in a portal server for client devices

(76) Inventors: Suresh K. Batchu, Sunnyvale, CA (US); Gregory J. Ziebold, Superior, CO (US); Luu D. Tran, Santa Clara, CA (US)

Correspondence Address: OSHA & MAY L.L.P./SUN, 1221 MCKINNEY, SUITE 2800, HOUSTON, TX, 77010, US

(21) Appl. No.: 10/621,918

(22) Filed: Jul. 16, 2003

(51) Int. Cl. G06F 15/16

(52) U.S. Cl. 709/228

(57) ABSTRACT

A method and system for implementing response buffering in a portal server. The method includes the step of receiving a request from a client device for content. The type of the client device is identified by processing the request. The content is buffered in accordance with the type of the client device. The content is then transmitted to the client device in response to request, wherein the content is formatted in accordance with the type of the client device.

This application is related to commonly assigned copending U.S. patent application “A METHOD AND SYSTEM FOR CUSTOMIZABLE CLIENT AWARE CONTENT SELECTION AND RENDERING IN A PORTAL SERVER” by Sambhus et al., filed on ______, Serial No. ______, Attorney Docket No. SUN-Po3oo87, and “A METHOD AND SYSTEM FOR CLIENT AWARE CONTENT AGGREGATION AND RENDERING IN A PORTAL SERVER” by Sambhus et al., filed on ______, Serial No. ______, Attorney Docket No. SUN-Po3oo86, which are both incorporated herein in their entirety.

### TECHNICAL FIELD

The present invention relates generally to portal servers and, in particular, to portal servers having client aware content formatting suitable for different types of client devices.

### BACKGROUND ART

The use of Web portals has become widespread for obtaining information, news, entertainment, and the like, via the World Wide Web. A Web portal is generally a Web “supersite” that provides a variety of services including Web searching, news, white and yellow pages directories, free e-mail, discussion groups, online shopping and links to other sites. The Web portal term is generally used to refer to general purpose sites, however, it is increasingly being used to refer to vertical market sites that offer the same services, but only to a particular industry such as banking, insurance or computers, or fulfill specific needs for certain types of users, for example, business travelers who are often away from their office or their primary point of business.

Certain types of Web portals have evolved into customized, user type specific sources of information. One example would be a corporate Web site, wherein an internal Web site (intranet) provides proprietary, enterprise-wide information to company employees as well as access to selected public Web sites and vertical-market Web sites (suppliers, vendors, etc.). Such a Web site would typically include a customized search engine for internal documents as well as the ability to customize the portal page for different user groups and individuals. Access to such customized Web sites by business travelers, or other types of users who require concise prompt access to information, is a highly sought-after goal. For example, for a mobile user (e.g., business traveler), it would be very advantageous to obtain wireless access to a Web portal via a portable handheld device, such as a cell phone or a wireless PDA. However, presentation of information on the small screens typical with such portable handheld devices requires customization of the Web portal and the formatting of the data it provides.

Standards have been developed to provide a widely used method of formatting data for the smaller screens of portable handheld devices. One such standard is WML (Wireless Markup Language). WML is a tag-based language used in the Wireless Application Protocol (WAP). WML is an XML document type allowing standard XML and HTML tools to be used to develop WML applications. WAP is a standard for providing cellular phones, pagers and other handheld devices with secure access to e-mail and text-based Web pages. WAP provides a complete environment for wireless applications that includes a wireless counterpart of TCP/IP and a framework for telephony integration such as call control and phone book access. WAP features the Wireless Markup Language (WML) and is a streamlined version of HTML for small screen displays. It also uses WMLScript, a compact JavaScript-like language that runs in limited memory. WAP is designed to run over all the major wireless networks in place now and in the future.

As the number of different types of access devices proliferates, conventional portal servers are not equipped to provide the appropriate markup for each type of device. Each cellular phone or personal digital assistant (PDA) device understands a different type of markup language. For example, a PDA may have a completely different display than a mobile phone. Examples of types of markup language include HyperText Markup Language (HTML) commonly used for PC-based applications, Wireless Markup Language (WML) for mobile applications, Compact HTML (CHTML) for small information appliances, and Extensible HTML (XHTML) as an HTML alternative language.

The most commonly implemented path is to use a desktop PC-based HTML type of markup, but this does not work on many non-PC access devices. For example, in a mobile phone type of access device, there is not a standard or universal type of markup language. There are several different types of markup language with each phone manufacturer and/or service provider using its own markup for a preferred “look-and-feel” of the device. In conventional portal server approaches, it is very difficult and not cost effective to handle the thousands of different access devices currently available. Because of this current difficulty and the expectation that the number of different markups required is only likely to increase, there must be a way to handle different types of access devices without having to develop a device-specific content for each. Further, it would be advantageous to have the ability to present a different markup as desired to the content displayed on a given access device.

In addition to the problems portal servers have in formatting the content for display on non-PC type client devices, the mechanism for delivering the actual data comprising the content may not be compatible with certain types of client devices. For example, many mobile client devices (e.g., cell phones, pagers, etc.) do not have the hardware resources of a PDA (personal digital assistant), let alone a desktop PC. Such devices have problems properly receiving and processing content received from the portal server if that content is not delivered to them in a manner commensurate with their relatively limited onboard embedded processing capability.

Thus, it would be desirable to have a more intelligent system so that, based on the type of access device detected, content can be supplied in an appropriate type of markup and in the appropriate type of data format. Although tools are in place (e.g., wirelessly connected portable handheld devices, WML and WAP based communications standards, customized Web portals, etc.) to provide customized, application specific, information to business travelers and other various types of users via portable handheld devices, existing prior art applications and methods are still generally targeted towards desktop implementations.

### DISCLOSURE OF THE INVENTION

The present invention provides a solution that can format, fit and tailor content presented from a Web site or a Web portal with respect to a particular device of an individual user. The present invention automatically formats the information in accordance with the hardware and/or software requirements of a particular client device.

In one embodiment, the present invention is implemented as a method for response buffering in a portal server. The method includes the step of receiving a request from a client device for content. Processing the request identifies the type of the client device. The content is buffered in accordance with the type of the client device. The content is then transmitted to the client device in response to request, wherein the content is formatted in accordance with the type of the device. As appropriate to the circumstances of the user, the client device can be a portable handheld device such as a cellular phone, a wirelessly connected PDA (personal digital assistant), or the like.

In one embodiment, the content is formatted by segmenting the content in accordance with the type of the device. The content can be buffered into a plurality of segments and the response provided to the client device by transmitting the segments. In one embodiment, the segments are pages, wherein the pages are sized in accordance with the hardware or software requirements of the client device.

In a further embodiment, access to buffered response content for the client device is controlled to provide security. Controlling access to buffered response content can include invalidating buffered response content for the client device when a session for the client device ends.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows a diagram showing the operation of a system for implementing response buffering in a portal server in accordance with one embodiment of the present invention.

FIG. 2 is a block diagram of a portal server interface structure according to one embodiment of the present invention.

FIG. 3 shows a diagram of a system showing the interaction between a rendering engine and a response buffer service in accordance with one embodiment of the present invention.

FIG. 4 shows a diagram of a process depicting the basic operating steps of a response buffering process in accordance with one embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be understood to one of ordinary skill in the art that the present invention may be practiced without these specific details. In other instances, well known methods, procedures, components, and circuits have not been described in detail as not to unnecessarily obscure aspects of the present invention.

### Notation and Nomenclature

Some portions of the detailed descriptions which follow are presented in terms of procedures, steps, logic blocks, processing, and other symbolic representations of operations on data bits within a computer memory. These descriptions and representations are the means used by those skilled in the data processing arts to convey most effectively the substance of their work to others skilled in the art. A procedure, computer executed step, logic block, process, etc., are here, and generally, conceived to be self-consistent sequences of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing,” “examining,” “accessing,” “routing,” “determining,” “transmitting,” —storing,” or the like, refer to the action and processes of a computer system, or similar electronic computing device, that manipulates and transforms data represented as physical (electronic) quantities within the computer system's registers and memories into other data similarly represented as physical quantities within the computer system registers or memories or other such information storage, transmission, or display devices

Embodiments of the present invention provide a solution that can format and tailor content presented from a Web site or a Web portal with respect to a particular device of an individual user. The present invention automatically formats the information in accordance with the hardware and/or software requirements of a particular client device. Embodiments of the present invention and their benefits are further described below.

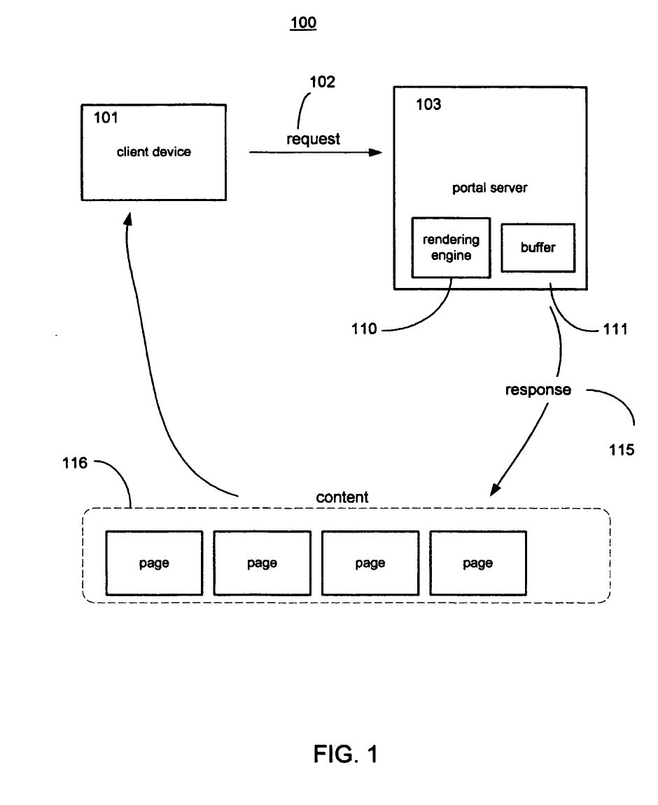

FIG. 1 shows a diagram showing the operation of a system 100 for implementing response buffering in a portal server in accordance with one embodiment of the present invention. As depicted in FIG. 1, a client device 101 transmits a request 102 to access content provided by a portal server 103.

In the system 100 embodiment, the client device 101 can be one of a number of different types of client devices. Such client devices include, for example, a PDA (personal digital assistant), a cell phone, a pager device, a text messenger device, or the like, in addition to a desktop computer system or lap top computer system. Embodiments of the present invention function in part by ensuring a response to the request 102 is formatted in accordance computer system resources of the client device 101 in addition to any screen constraints (e.g., display size) of the client device 101. A response provided to the client device 101 is tailored for efficient processing by, for example, the comparatively limited embedded computer system resources of portable type client devices (e.g., PDAs, cell phones, etc.).

The system 100 embodiment determines the type of the client device 101 by processing the request 102. For example, the request 102 typically includes identifying information informing the portal server 103 of the type of the client device. The portal server 103 uses this identifying information to format and tailor its response.

The system 100 embodiment utilizes a rendering engine 110 and a buffer 111 to format the response 115. The rendering engine 110 and the buffer 111 segment the response 115 and buffer the segments in accordance with, for example, the computer system resources constraints of the client device 101. This is shown in FIG. 1 as the content 116 having a plurality of segments, or pages, that are sized to be efficiently processed by the computer system resources of the client device 101. For example, in a case where the client device 101 is a cell phone, the pages of the content 116 are sized to ensure each individual page can be loaded by the client device 101 without exceeding its hardware or software resources, such as, for example, by overflowing its input buffers.

In one embodiment, system 100 also provides security for the client device 101. In this embodiment, access to buffered response content for the client device 101 is controlled during the device's session. The controlled access ensures no other client device can access any buffered response content stored on the portal server 103. Access can be controlled for the duration of the device's session. When a session ends, buffered response content for the client device can be invalidated, or otherwise discarded, to prevent any unauthorized access.

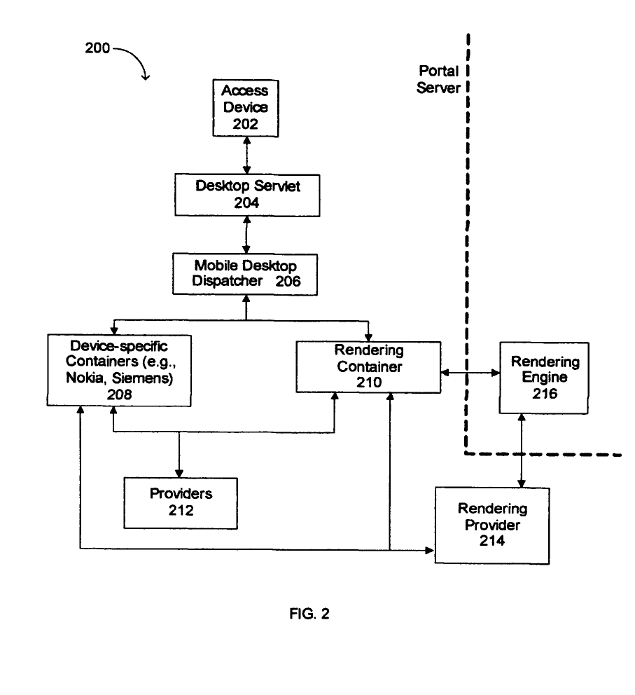

FIG. 2 shows a more detailed block diagram of a system 200 implementation of a portal server interface structure in accordance with one embodiment of the present invention. The system 200 embodiment shows additional components of a portal server configured to survice content requests from handheld mobile access type client devices (e.g., access devices).

As depicted in FIG. 2, the access device 202 comprises a typical wireless mobile access client device. Access Device 202 can interface to Desktop Servlet 204. The Access Device can be a mobile phone, a PDA, or any appropriate computing device. The Desktop Servlet can present the front page, which can contain an assortment of channels of content and the like, to the Access Device. Desktop Servlet 204 can interface to Mobile Desktop Dispatcher 206. Based on the type of Access Device and the configuration of the portal, a request from the Access Device can be sent to Device-specific Containers 208 and/or Rendering Container 210. There can be a number of Device-specific Containers representing instances for different types of devices, such as Nokia or Siemens type mobile phone devices. Rendering Container 210 can include AML templates from the content providers. The containers can act to aggregate and present the content in a format suitable for a particular application or Access Device type.

Rendering Container 210 can aggregate content from Providers 212 and/or Rendering Provider 214. Rendering Container 210 can also interface to Rendering Engine 216. The Rendering Engine can receive a document in AML format and translate the document into a device-specific markup language. Providers 212 can be “native” Providers that can interface to the Device-specific Containers 208 and/or Rendering Container 210. Native Providers can be designated for Access Devices supported by the Portal Server and can generate device-specific markup language instead of a generic language, such as AML. Rendering Provider 214 can interface to Device-specific Containers 208 and/or Rendering Container 210. The Rendering Provider can provide content in AML format.

According to an embodiment, in one mode of operation, a request can arrive via the Access Device from an authenticated user to the Desktop Servlet. The Desktop Servlet can begin to form the front page, but the proper format suitable for the Access Device must be determined. Based on the type of Access Device and/or on the configuration of the Portal Server, a request may be forwarded to the Rendering Container, for example. The term “rendering” as used herein implies the use of AML-based templates. The Rendering Container must be able to present the different channels desired based on the Access Device type and/or configuration. The content of the channels themselves can be generated by a provider, which can include content from a native Provider 212 or a Rendering Provider 214. Native Providers 212 can generate actual content in a device-specific format, but Rendering Provider 214 can generate actual content in AML, or a suitable generic language, format. The providers can give their content to the containers for aggregation. A container, such as Rendering Container 210 can include information or copies of content from different providers and can present an integrated view of a document in AML format. A post-processing step may be used to convert an AML document into a device-specific markup document. Such post-processing can occur when Rendering Container 210 calls Rendering Engine 216, which can convert the document into whatever markup is needed for presentation to Access Device 202. For a document received in AML format, Rendering Engine 216 can translate the document based on the type of Access Device 202. Thus, different markups can be sent back from Rendering Engine 216. For example, if the Access Device is a Nokia phone, WML can be sent back from Rendering Engine 216. The type of Access Device can be distinguished and the Rendering Engine can return the appropriate markup. The post-processed content can then go back to the Rendering Container 210 and out to the Access Device 202.

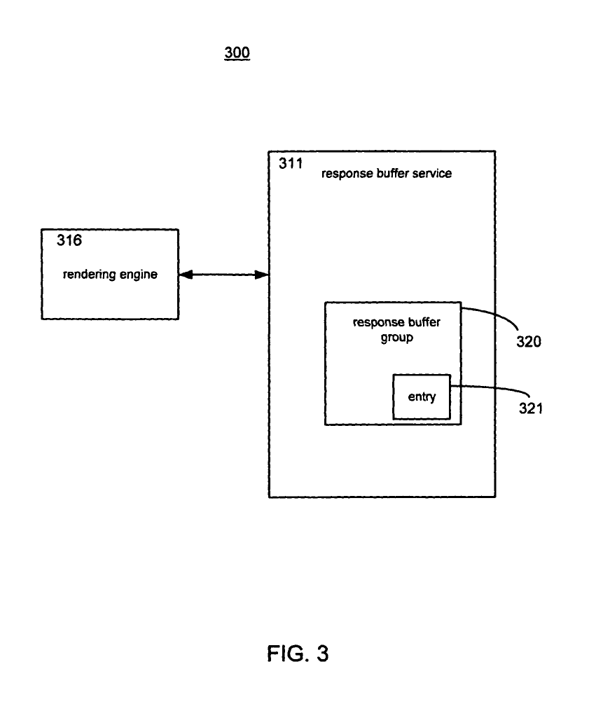

FIG. 3 shows a diagram of a system 300 showing the interaction between a rendering engine 216 and a response buffer service 311.

In the system 300 embodiment, as described above in the discussion of FIG. 2, the rendering engine 316 receives content in AML markup and processes the AML markup to convert it into a markup that the requesting device (e.g., access device 202) can understand. Rendering Engine 316 also has the ability to dynamically split up, or segment, the response data into multiple segments to accommodate the response size constraints of the requesting device. Each of these segment sizes is processed to be less than the maximum allowed size for that device. These segments (e.g., the pages of the content 116 shown in FIG. 1) can be doubly linked through back and next links.

In the system 300 embodiment, a buffered response is usually segmented (as shown in FIG. 1) and only the first segment is typically sent to client the first time around. The segment (or page) sent to the client has links to gain access to next segment (next link) and previous segments (back link). These links are made to point to a subsystem that knows how to serve these requests. The subsystem servicing these kind of requests typically has a URL endpoint and typically runs in the same JVM (Java virtual machine) on which the buffered response was generated.

The system 300 embodiment implements access control to buffered response content to provide security for the client. In the present embodiment, the buffered response content is accessible only to one client, the client to whom the response was generated in the first place. The buffered response content is not shown to any other client.

In one embodiment, buffered response content is stored in a cache memory. The segments/pages of the buffered response content are stored such that internal interfaces are not exposed (e.g., to other clients). In the present embodiment, the rendering engine 316 is responsible for populating and managing cache storage.

The response buffer entry 321 provides a “wrapper” for the cache objects comprising the stored buffered response content. The response buffer entry 321 also maintains the request URL that generated the content in the cache, and a number to uniquely identify this response buffer entry.

The response buffer group 320 provides a place where all the response buffers for a given client are managed. The response buffer group 320 provides reference for most recent valid entries, a list of request URLs for the recently invalidated entries, and the like.

Referring still to the system 300 embodiment of FIG. 3, in implementing access control, only one response for a given client is buffered at any one time. This is usually the most recent response. As new responses are processed by the rendering engine 316, previous buffered response are automatically invalidated. Invalidated buffered responses would typically never be shown to the client. The client's browser may have cached the data and ‘back’ buttons might still show an invalidated response, but server components never serve invalidated responses.

Due to the fact that privacy is of the utmost importance, one client's buffered response should never be accessible to any other client. For example, if a client tries to access invalidated response buffers it is typically redirected to the URL that generated that response in the first place. If that request URL is not available, it is then sent to the main page. For example, if the client is not logged in when it tries to access buffered data it should automatically be directed to the login page.

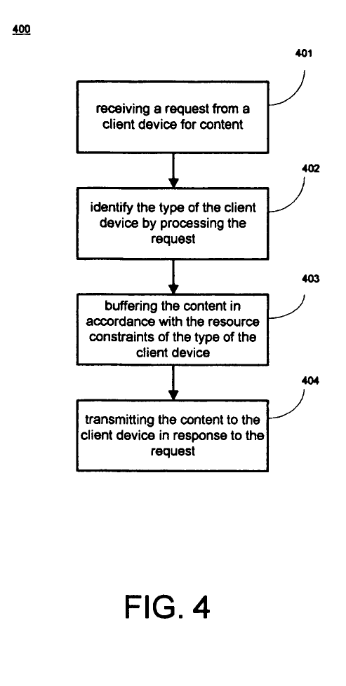

Referring now to FIG. 4, a diagram of a process 400 depicting the basic operating steps of a response buffering process in accordance with one embodiment of the present invention is shown. As depicted in FIG. 4, process 400 shows the basic operating steps of a computer implemented method as performed by a portal server (e.g., portal server 103 of FIG. 1).

Process 400 begins in step 401, where a request (e.g., request 102) is received from a client device (e.g., client device 101) for content from a portal server. In step 402, processing the request identifies the type of the client device. As described above, the type of the client device informs the portal server of any particular resource constraints of that client device. In step 403, the content for servicing the response is buffered in accordance with the type of the client device. As described above, the content data comprising the response is segmented into a plurality of segments, or pages, sized in accordance with the resource constraints of the client device. In step 404, the content is then transmitted to the client device in response to request. Thus, when the client device receives the content, the content is specifically formatted and tailored in accordance with the resource constraints for the type of the device. As described above, depending on the requirements of the user, the client device can be a portable handheld device such as a cellular phone, a wirelessly connected PDA, or the like.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order best to explain the principles of the invention and its practical application, thereby to enable others skilled in the art best to utilize the invention and various embodiments with various modifications as are suited to the particular use contemplated. It is intended that the scope of the invention be defined by the claims appended hereto and their equivalents.

1. A method for implementing response buffering in a portal server, comprising:
receiving a request from a client device for content;
identifying for the type of the client device by processing the request;
buffering the content in accordance with the type of the client device; and
transmitting the content to the client device in response to request, wherein the content is formatted in accordance with the type of the client device.

2. The method of claim 1 wherein the content is formatted by segmenting the content in accordance with the type of the client device.

3. The method of claim 2 wherein buffering the content in accordance with the type of the client device includes buffering the content into a plurality of segments and transmitting the segments to the client device.

4. The method of claim 1 further comprising:
buffering the content into a plurality of pages, wherein the pages are sized in accordance with the requirements of the client device.

5. The method of claim 4 wherein the pages are sized in accordance with a response size constraint of the client device.

6. The method of claim 1 further comprising:
controlling access to buffered response content for the client device.

7. The method of claim 6 further comprising:
invalidating buffered response content for the client device when a session for the client device ends.

8. The method of claim 1 further comprising:
buffering the content for the client device by using a cache memory.

9. A system for implementing response buffering in a portal server, comprising:
a computer system including a processor and a memory, the memory having computer readable code which when executed by the processor cause the computer system to perform a method comprising:
receiving a request from a client device for content;
identifying for the type of the client device by processing the request;
buffering the content in accordance with the type of the client device; and
transmitting the content to the client device in response to request, wherein the content is formatted in accordance with the type of the client device.

10. The system of claim 9 wherein the content is formatted by segmenting the content in accordance with the type of the client device.

11. The system of claim 10 wherein buffering the content in accordance with the type of the client device includes buffering the content into a plurality of segments and transmitting the segments to the client device.

12. The system of claim 9 further comprising:
buffering the content into a plurality of pages, wherein the pages are sized in accordance with the requirements of the client device.

13. The system of claim 12 wherein the pages are sized in accordance with a response size constraint of the client device.

14. The system of claim 9 further comprising:
controlling access to buffered response content for the client device.

15. The system of claim 14 further comprising:
invalidating buffered response content for the client device when a session for the client device ends.

16. The system of claim 9 further comprising:
buffering the content for the client device by using a cache memory.

17. A computer readable media for implementing response buffering in a portal server, the media having computer readable code which when executed by a processor of a computer system cause the computer system to implement a method comprising:
receiving a request from a client device for content;
identifying for the type of the client device by processing the request;
buffering the content in accordance with the type of the client device; and
transmitting the content to the client device in response to request, wherein the content is formatted in accordance with the type of the client device.

18. The computer readable media of claim 17 wherein the content is formatted by segmenting the content in accordance with the type of the client device.

19. The computer readable media of claim 18 wherein buffering the content in accordance with the type of the client device includes buffering the content into a plurality of segments and transmitting the segments to the client device.

20. The computer readable media of claim 17 further comprising:
buffering the content into a plurality of pages, wherein the pages are sized in accordance with the requirements of the client device.

21. The computer readable media of claim 20 wherein the pages are sized in accordance with a response size constraint of the client device.

22. The computer readable media of claim 17 further comprising:
controlling access to buffered response content for the client device.

23. The computer readable media of claim 22 further comprising:
invalidating buffered response content for the client device when a session for the client device ends.

24. The computer readable media of claim 17 further comprising:
buffering the content for the client device by using a cache memory.
